(19) United States
(12) Patent Application Publication
(10) Pub. No.: US 2007/0172561 A1
(43) Pub. Date: Jul. 26, 2007

(54) Method for controlling microbial contamination of a vacuum-sealed food product

(75) Inventors: John Alfred Hirschey, Middleton, WI (US); Dennis Lloyd Seman, Cottage Grove, WI (US); Andrew Leszek Milkowski, Cottage Grove, WI (US); Gary R. Skaar, Marshall, WI (US); Harry James Overly III, Schaumburg, IL (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc.

(21) Appl. No.: 11/250,648

(22) Filed: Oct. 14, 2005

Related U.S. Application Data
(63) Continuation of application No. 10/201,609, filed on Jul. 23, 2002, now abandoned.

(51) Int. Cl. A23B 4/20

(52) U.S. Cl. 426/326

(57) ABSTRACT

Methods for controlling contamination of a food product are provided which utilize introduction of an antimicrobial solution to a food package prior to vacuum sealing the package. These methods utilize surface tension and/or capillary action created during a vacuum heat sealing process to efficiently create a uniform distribution of antimicrobial solution over the surface of a food. This method insures rapid and effective coating of the product with the antimicrobial agent.

### FIELD OF THE INVENTION

The invention relates to methods for controlling contamination of vacuum-sealed food products by application of microbial agents to the surface of food products.

### BACKGROUND

The presence of food spoilage organisms and pathogens in foods is a major concern to the food processing industry, government regulatory agencies, and food consumers. Foodborne pathogens have been responsible for several recent food poisoning outbreaks, some of which have resulted in serious illness and death. In addition, the presence of pathogenic organisms in foods has led to numerous product recalls, product losses, and considerable negative publicity to the food industry. For example, a report of a case of listeriosis associated with the consumption of turkey franks provided direct evidence of the infection by Listeria monocytogenes linked to poultry products. Barnes et al., Morbid. MortaL. Weekly Rep. 38:267-268 (1989). It has also been shown that L. monocytogenes occurs commonly in sea foods, poultry, and meats including cured and fermented meats. See, for example, Buchanan et al, Appl. Environ. Microbiol. 55:599-603 (1989); Bailey et al., J. Food Prot. 52:148-150 (1989); Gitter, Vet. Res. 99:336 (1976); and Farber et al., Can. Inst. Food Sci. Technol. J. 21:430-434 (1988).

Although food is generally inspected prior to packaging, it is presently not practical to inspect each package of food for complete application of an antimicrobial agent to the product. Incomplete or otherwise faulty application reduces the efficacy of the antimicrobial agent and/or can lead to bacterial contamination that places the food-consuming public at risk. U.S. Pat. Nos. 5,573,800 and 5,573,801 provide an antimicrobial solution that includes nisin and/or pediocin along with a chelator, and processes for using the antimicrobial solution to treat the surface of foods by applying the composition to the entire surface of the food. In certain embodiments, the antimicrobial solution is contained on packaging films which are applied to foods. The antimicrobial solution is deposited on the surface by spraying, dipping, mixing, or by impregnating or coating the antimicrobial agent onto a food casing.

U.S. Pat. No. 5,085,873 provides a process for the treatment of a hydrated food product by depositing an antimicrobial mixture containing lactoperoxidase, a thiocyanate, and an oxygen donor on the surface of the hydrated food product. The antimicrobial mixture is deposited on the surface by pulverizing, immersion in a bath, or through the use of an antimicrobial agent-containing packaging.

U.S. Pat. No. 6,149,952 discloses a method for determining the presence of contaminating bacteria in a packaged food by using a permeable hydrophilic polymeric composition containing an indicator to line a package. The indicator is capable of detecting gases originating from contaminating bacteria.

There remains a need for more efficient, more effective, and simplified methods for treating the surface of a food product with an antimicrobial solution. Furthermore, there remains a need for methods to assure that an antimicrobial surface treatment is effective at covering the entire food surface. The current invention provides an efficient, effective, and simplified method for controlling contamination of a food product. Furthermore, the current invention provides a simple yet effective method for assuring effective food surface coverage by an antimicrobial agent.

### SUMMARY OF THE INVENTION

The present invention provides methods utilizing surface tension and/or capillary action created during a vacuum heat sealing process to efficiently create a uniform distribution of antimicrobial solution over the surface of a food. This method insures rapid and effective coating of the product with the antimicrobial agent. The uniform distribution of antimicrobial solution on the food product is generally in the form of a surface layer and provides a highly concentrated agent to kill pathogens. This method is especially adapted for packaging wieners or similar type processed meat food products.

The present invention provides a method for controlling contamination in a vacuum-sealed food product, said method comprising:

(1) providing a food product with a food surface;

(2) providing a flexible vacuum-sealable package having a package cavity for holding the food product;

(3) introducing an effective amount of an antimicrobial solution containing an antimicrobial agent into the package cavity;

(4) placing the food product into the package cavity before, during, or after introducing the antimicrobial solution into the food cavity; and

(5) vacuum sealing the food product in the package such that the package cavity and the package shrinks around the food product and the antimicrobial solution is uniformity dispersed over the food surface, thereby controlling contamination in the vacuum-sealed product.

In preferred embodiments, the food product is a processed meat (e.g., wieners or sliced meat products such as bologna, ham, turkey, and the like); in especially preferred embodiments, the food product is one or more wieners. In preferred examples of embodiments involving about 5 to 10 wieners, about 0.5 to about 10 cm³ of the of the antimicrobial solution is introduced to the package cavity; preferably the total free liquid in the package (defined as the sum of added antimicrobial solution plus surface water on the food product) is no more than about 10 cm³. Thus, by drying the food surfaces prior to packaging, more antimicrobial solution can, if desired, be used without adversely affecting vacuum sealing properties or increase sealing failure rates. Once the food product is vacuum sealed, the antimicrobial solution is uniformly dispersed over the food surface and provides the desired protection. The present invention does not require applying the antimicrobial solution to the food product surfaces prior to the food product being placed in the package cavity or being sealed.

The antimicrobial solution used in the methods of the current invention contains one or more antimicrobial agents that can include any effective food-grade antimicrobial compound. Such antimicrobial agents include, for example, food-grade acids, bacteriocins, spice extracts, plant extracts, inorganic salts, methyl paraben, ozonated water, or mixtures thereof, and the like. Especially preferred antimicrobial agents include hop extracts, tertiary butylhydroquinone (TBHQ), cetyl pyridium chloride, bacteriocins, and mixtures thereof. For purposes of this invention, an “effective amount” of the antimicrobial solution or antimicrobial agent is an amount sufficient to control and/or prevent microbial growth for at least about 4 months under refrigerated storage conditions.

Another aspect of the current invention encompasses drying the surface of the food product (i.e., removing excess surface water or moisture) before introducing the food product into the package cavity and contracting the surface with the antimicrobial solution. The antimicrobial solution can be introduced into the package cavity before the food product is placed in the package cavity, at the same time as the food product is placed in the package cavity, or after the food product is placed in the food cavity. Alternatively, the antimicrobial solution can be introduced into the package cavity in multiple portions. For example, a portion of the antimicrobial solution could be added via the surface of the food product (i.e., at the same time as the food product) followed by a second portion added after the food product has been placed in the food cavity. In another example specifically adapted for packaging wieners, a portion of the antimicrobial solution can be sprayed onto the ends of the wieners (i.e., areas having non-uniform surfaces and, thus, most likely to harbor bacteria and/or microbes). Other addition sequences using multiple portions of the antimicrobial solution can be used if desired.

Embodiments of the current invention wherein the food surface is dried prior to being introduced into the food cavity offer several advantages. For example, if the antimicrobial solution is applied to the food surface by dipping in an antimicrobial solution and/or by spraying with the antimicrobial solution, the applied dose can be controlled using liquid viscosity (liquid layer thickness) and concentration. Additionally, surface drying and controlled addition of the antimicrobial solution allows better control of the heat seal area; keeping excess liquid away from the heat seal area allows better vacuum sealing and reduced seal failure. Additionally, the antimicrobial solution will not be significantly diluted by water on the surface of the food product. Thus, increased pathogen kill and/or protection can be expected. For example, standard wieners (about 0.1 lb each), without pre-drying, would normally have up to about 0.3-0.6 cm³ surface water/wiener before packaging which, of course, would significantly dilute the antimicrobial solution. By removing this water prior to introducing the antimicrobial solution, higher levels of the antimicrobial agent can be achieved without adversely affecting the sealing process. Using such a drying step, also allows excess antimicrobial solution to be recycled since it is not diluted with surface water. Thus, for example, pre-dried wieners could be dipped into antimicrobial solution; any the excess dripping off could be collected and reused without diluting the antimicrobial solution.

In another aspect, the current invention encompasses heating the surface of the food product (preferably after removing excess surface water or moisture from the surface) before contracting the surface with the antimicrobial solution. Generally, it is preferred that the surface of the food product is heated to about 150 to about 212° C. just prior to adding the antimicrobial solution. Alternatively, the antimicrobial solution could be heated to about 120 to about 180° C. prior to contacting the surface of the food product. Such heating (of either the food surface directly or via a heated antimicrobial solution) will modify the surface tension and/or viscosity of the antimicrobial solution and thereby provided significantly better coverage, diffusion rates, and microbe kill.

In another aspect, the current invention provides improved antimicrobial solutions containing both antimicrobial agents and marking agents, and methods using these improved antimicrobial solutions for monitoring coverage of a food product surface by the antimicrobial agent. In certain aspects, the antimicrobial agents are bactericidal agents.

In this aspect, the present invention provides a method for controlling contamination in a vacuum-sealed food product, said method comprising:

(1) providing a food product with a food surface;

(2) providing a flexible vacuum-sealable package having a package cavity for holding the food product;

(3) introducing an effective amount of an antimicrobial solution containing an antimicrobial agent into the package cavity;

(4) introducing a detectable marking agent into the package cavity;

(5) placing the food product into the package cavity before, during, or after introducing the antimicrobial solution and the detectable marking agent into the food cavity;

(6) vacuum sealing the food product in the package such that the package cavity and the package shrinks around the food product and the antimicrobial solution and marking agent are uniformity dispersed over the food surface; and

(7) detecting the marking agent to assess proper introduction and dispersion of the antimicrobial agent throughout the package cavity, thereby controlling contamination in the vacuum-sealed product. Preferably the marking agent is included in the antimicrobial solution along with the antimicrobial agent. Preferably the marking agent allows the manufacture to easily confirm substantially complete coverage of the food surfaces by the marking agent and, by implication, the antimicrobial agent. This method is especially adapted for packaging processed meats (e.g., wieners and sliced meat products such as bologna, ham, turkey, and the like).

In preferred embodiments, the marking agent is selected from a food-grade wetting agent, a food-grade color, a food-grade dye, a food-grade luminescent compound, a food-grade fluorescent compound, a food-grade odor-producing compound, as well as food-grade activators and suppressors of any of the aforementioned marking agents. In a preferred embodiment, the marking agent is a water soluble, food-grade dye that is compatible with the color of the food (i.e., can be easily seen to assess coverage) but then diffuses into the food without affecting the color of the food in a visually noticeable way after it diffuses into the food. In another preferred embodiment, a supersaturated aqueous solution or a non-aqueous soluble marker can be used as the marking agent. In such a system, the marking agent can initially form an opaque solution due to the formation of small crystals; over time, the solution will clear.

In certain preferred embodiments, the detectable antimicrobial compounds of the current invention are combined with the methods described above for controlling contamination of a vacuum-sealed food product and/or controlling contamination by using a drying step. For these embodiments, the method further comprises detecting the marking agent.

The current invention also includes two-step methods using the detectable antimicrobial solutions, which include a marking agent, and a separate marking partner associated with the food or the food surface thereof. In the two-step methods, the marking partner gives the food a characteristic that is unusual for the food. In these embodiments, the marking agent then changes the characteristic in a detectable manner. For example, the marking partner may be a food dye that provides a food an unusual color that is reversed when the food is exposed to a marking agent. By using this method, a process may be monitored to assure that the surface of a food is substantially completely covered by an antimicrobial agent. The marking partner may be any class of food-grade compounds, as described above, that are appropriate for the marking agent.

### BRIEF DESCRIPTION OF THE DRAWINGS

FIG. 1 provides a general flowchart of the present invention.

FIG. 2 provides a flowchart of the present invention incorporating a pre-drying step and coverage assessment step.

### DESCRIPTION OF THE PREFERRED EMBODIMENTS

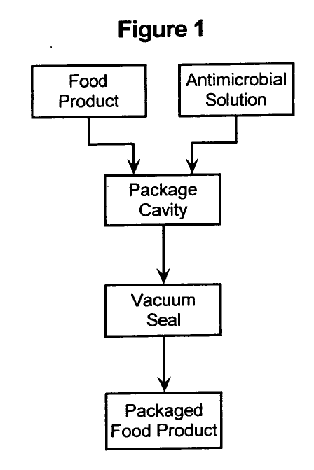

This invention provides a method for controlling contamination of a vacuum-sealed food product. A food with a food surface and a heat-sealable package having a package cavity for holding the food are provided. An antimicrobial solution and the food product are introduced into the package cavity. The order of addition is not critical. Thus, for example, the antimicrobial solution can be added before, at the same time, or after the food product. The antimicrobial solution and the food product can be added separately or in combination (e.g., food product sprayed with, or dipped into, the antimicrobial solution). If added in combination, it is not necessary that the entire exterior surface of the food product is covered with the antimicrobial solution; in fact, to prevent problems associated with sealing the package, it is generally preferred that the exterior surface of the food product is not covered entirely with the antimicrobial solution prior to vacuum sealing the package. Preferably the antimicrobial solution is added to only a portion of the food surface. The package is then vacuum sealed over the food and the vacuum-sealed food product is then stored under conditions that allow the antimicrobial solution to cover the surface of the food, thus forming the vacuum-sealed food product. The general process is illustrated in FIG. 1.

The invention is applicable to any food product which is to be vacuum sealed, particularly those which may benefit from application of a controlled amount of an antimicrobial agent, particularly an antibacterial agent, to the food surface. It is contemplated that the solutions and methods of the invention have applicability to both animal-derived and plant-derived food products including, but not limited to, raw meat cuts, processed meat (e.g., wieners and sliced meat products such as bologna, ham, turkey, and the like), hams, lamb, steak, hamburger, poultry including chicken, turkey, duck, and goose, as well as fish, dairy products such as semi-soft and hard cheeses, processed cheese, vegetable products including lettuce, tofu, coleslaw, soybean derived protein substitutes for meat, fruits, and the like. The food may be sliced or unsliced. Non-limiting examples of processed meats that may be used with the current invention include cooked or smoked sausages such as frankfurters or wieners and ready-to-eat sliced meat products such as luncheon meats (e.g., bologna), ham, turkey, and the like. The present invention is especially adapted to packaging wieners; generally such packages contain 4 to 12, and preferably 5 to 10, wieners.

A food scientist can use well-known methods to determine the total amount of antimicrobial agent and volume of antimicrobial solution to apply to the vacuum-packed foods to assure the desired coverage, preferably complete coverage, of the food stuff. Specific modification of the temperature, surface tension, viscosity, and volatility of the solution may be made to achieve the desired distribution of active ingredients(s) throughout the package. Preferably, this distribution is complete coverage of the surface of the food being vacuum sealed.

For example, and not intended to be limiting, a package containing about 8 to 12 wieners and about 0.5 to about 10 cm³ of the of the antimicrobial solution will generally prove to be satisfactory. As noted above, the total amount of free liquid is preferably less than about 10 cm³. The antimicrobial solution can have a viscosity similar to that of water or can be more or less viscous so long as it is uniformly distributed over the exterior surfaces of the food product after the package is vacuum sealed. The amount of antimicrobial agent, viscosity, surface tension, and similar characteristics can be varied to achieve the desired uniform distribution.

Preferably, in order to increase the ease and efficiency of coating the surface of the food with the antimicrobial solution, the solution is applied to only a portion of the food surface, or applied to only a portion of a heat-sealable package. In one preferred embodiment, the antimicrobial solution is sprayed on the top surface of the food being vacuum-packed. In another preferred embodiment, the antimicrobial solution is sprayed onto the surfaces most likely to harbor bacteria and/or microbes. Using wieners as an example, the end portions generally have non-uniform surfaces (i.e., wrinkles or other cavities). Bacteria and/or microbes located in such non-uniform surface areas will generally be more difficult to kill or otherwise eliminate. Thus, applying the antimicrobial solution directly onto these non-uniform surface areas will increase kill rates within these difficult areas and increase the overall effectiveness of the treatment. During or after the vacuum-packing process, substantially all of the remainder of the surface of the food is covered by the antimicrobial solution due to forces that are inherent in the vacuum sealing and packaging processes. Not intended to be limited by theory, it is believed that a combination of forces, including capillary action, act on the antimicrobial solution during and after the vacuum-packing process, to uniformly distribute the antimicrobial solution over the entire exterior surface of the food.

Vacuum-packing procedures for foods are well-known in the art. For the current invention, any standard vacuum-packing system may be used. As known in the art, specific details of vacuum-packing procedures vary depending on the size and type of food that is being sealed. For example, but not intended to be limiting, where the food being vacuum-packed is a 5 to 10-pack of wieners, the vacuum-packing may be performed using commercially available packaging equipment using vacuum pressures of about 20 to 28 inches Hg and sealing temperatures appropriate for the packaging material employed.

Heat-sealable food packaging materials or films suitable for use in the present invention include materials typically used for heat-sealing procedures. For example, suitable films include cellulose materials and thermoplastic stretch or shrink films, and may be monolayer or multilayer films. Shrink films are preferably formed into heat shrinkable, biaxially-oriented bags. Suitable films include, for example, polymeric materials including cellulosic materials such as regenerated cellulose or cellulose carbamate, plastics such as homopolymers or copolymers of polyolefins (e.g., polypropylene, polyethylene, polyamides, polyethylene terphthalate, polyvinylidene chloride copolymers, ethylene-vinyl acetate copolymers, saran, polyvinylchloride, and the like), or proteinaceous films such as collagen. Generally, films having good flexibility are preferred as they can more closely and uniformly conform to variations in the contours of the product, thereby providing better liquid distribution throughout the package.

In certain preferred embodiments, the food packaging of the current invention is intended for wieners and includes two continuously extruded polymeric sheets that are molded to form upper and lower shells for the wieners. The sheets for these embodiments are typically molded into a continuous series of upper and lower halves of a tube-like shape that have a ½ circle form in cross section and run the entire length of the hot dog.

The antimicrobial solution used in the methods of the current invention contains an antimicrobial agent that can include any food-grade antimicrobial compound. The agent may be used individually or in combination with other agents. Although the antimicrobial solutions are water-based, other acceptable food-grade solvents can be used (e.g., alcohol, oil, and the like). If water-based, pH and other modifications may be made to allow distribution of agents not normally soluble in water.

Suitable antimicrobial agents may be effective against molds, yeasts, and/or bacteria. Suitable agents are believed to include, but are not limited to, antibacterial agents (also referred to as bactericidal agents) which are effective to kill or inhibit bacteria (e.g., antibiotics such as nisin, natamycin, subtilin) or Pediococcus—derived bacteriocins (e.g., pediocin); food-grade acids and salts of acids (e.g., acetic acid, lactic acid, malic acid, phosphoric acid, sorbic acid, benzoic acid, mixtures thereof, and the like); heat resistant antibacterial enzymes such as lysozyme; spice extracts having antibacterial properties; plant extracts having antibacterial properties (e.g., hop extracts); inorganic salts having antibacterial properties; and other agents such as liquid smoke, parabens, or ozonated water; mixtures of such agents can also be used. In certain preferred embodiments, the antimicrobial agent is selected from nisin, hop extracts, tertiary butylhydroquinone (TBHQ), cetyl pyridium chloride, bacteriocins, and mixtures thereof.

The antimicrobial solution should, of course, contain an effective amount of the desired antimicrobial agent or agents. The concentration of the antimicrobial agent can vary depending on the specific antimicrobial agent or agents used. The antimicrobial solution can be aqueous or non-aqueous based or may consist essentially of only the antimicrobial agent (i.e., essentially no carrier or solvent).

In the antimicrobial solutions of the current invention, such antimicrobial agents may include additives such as binding agents, buffers, emulsifiers, transfer aids, or chelating agents (e.g., ethylenediaminetetraacetic acid (EDTA) or its salts). These agents may enhance the antimicrobial effect of the agent or assist transfer of the antimicrobial solution to the food surface after vacuum sealing. Other ingredients which are normally used in the manufacture of, or for further treatment of, food packaging film may also be present in or on the film if desired, and they may be used in the same manner and amounts as if the antimicrobial agent had not been used. For example, anti-block and anti-static agents are frequently used with thermoplastic films.

In one non-limiting example of a production method according to the current invention for coating the surface of a wiener with an antimicrobial agent, one-half tube polymeric molds are formed as described above as a continuously extruded sheet. Wieners are placed on top of one of the one-half tubes (i.e., designated the lower tube) and a spray of antimicrobial solution is sprayed over the top surface of the wieners (either over the entire top surface or, more preferably, over both ends of the wieners) or an equivalent amount of antimicrobial solution is introduced into the lower tube. The upper tube is then applied on top of the wiener, and the lower and upper tubes are vacuum sealed. During and after the sealing process, the antimicrobial solution spreads over the entire surface of the wieners.

In another non-limiting example of a production method according to the current invention for coating the surface of a sliced processed meat product (e.g., bologna) with an antimicrobial agent, a bottom film layer having a suitable cavity for receiving the sliced processed meat product is prepared using conventional techniques. After placing an appropriate amount to the antimicrobial solution into the cavity and placing the sliced and stacked processed meat product within the cavity, a top film is applied and the bottom and top films are vacuum sealed. During and after the sealing process, the antimicrobial solution spreads up and around the exterior surfaces of the meat product.

This process is especially adapted for meat products having discrete areas of fat and lean meat since an essentially compete and continuous antimicrobial film can be obtained in spite of the different surface properties of the discrete areas. Simply dipping such a meat product in an antimicrobial solution or spraying such a meat product with an antimicrobial solution will generally leave areas unprotected. For example, with an aqueous based antimicrobial solution, the solution will tend to “bead up” on the fat-rich areas (i.e., such areas are not wetted), thereby leaving them essentially unprotected. Using the capillary action during the vacuum packaging of the present invention, the surface tension helps to insure complete and continuous coverage of the antimicrobial solution.

Another aspect of the current invention encompasses drying a surface of an article of food before applying the antimicrobial solution. Embodiments of the current invention wherein the food surface is dried prior to being introduced into the food cavity offer several advantages. For example, if the antimicrobial solution is applied to the food surface by dipping in an antimicrobial solution and/or by spraying with the antimicrobial solution, the applied dose can be controlled using liquid viscosity (liquid layer thickness) and concentration. Additionally, surface drying and controlled addition of the antimicrobial solution allows better control of the heat seal area. Keeping excess liquid away from the heat seal area allows better vacuum sealing and reduced seal failure. Additionally, the antimicrobial solution will not be significantly diluted by water on the surface of the food product. Thus, increased pathogen kill and/or protection can be expected. For example, a standard wiener, without pre-drying, would normally have about 0.3-0.6 cm³ surface water/wiener before packaging which, of course, would dilute the antimicrobial solution. By removing at least a portion, and preferably essentially all, of this surface water prior to introducing the antimicrobial solution, higher levels of the antimicrobial agent can be used without adversely affecting the sealing process. Using such a drying step, also allows excess antimicrobial solution to be recycled since it is not diluted with surface water. Thus, for example, pre-dried wieners could be dipped into the antimicrobial solution; any excess which drips off could be collected and reused without diluting the antimicrobial solution.

One of ordinary skill can determine effective volumes of antimicrobial solution for different foods using available methods, as described above. For methods of the current invention incorporating a drying step, typically lower volumes of antimicrobial solution are required; if desired, however, additional volumes can be added to potentially increase protection of the food product.

Virtually any procedure for surface coating foods prior to packaging can be used for the current invention. Such procedures include, for example, dipping and spraying. Methods for applying composition to food packaging are well known in the art and includes methods such as slugging, spraying, and internally coating while stirring, as described in U.S. Pat. No. 4,171,381. Alternatively, the antimicrobial solution may be directly introduced into the packaging, before, after, or at the same time as the food product is introduced into the packaging.

The current invention also provides improved antimicrobial solutions containing both antimicrobial agents and marking agents, and methods using these improved antimicrobial solutions for monitoring coverage of a food product surface by the antimicrobial agent. In this aspect, the present invention provides a method for controlling contamination in a vacuum-sealed food product, said method comprising:

(1) providing a food product with a food surface;

(2) providing a flexible vacuum-sealable package having a package cavity for holding the food product;

(3) introducing an effective amount of an antimicrobial solution containing an antimicrobial agent into the package cavity;

(4) introducing a detectable marking agent into the package cavity;

(5) placing the food product into the package cavity before, during, or after introducing the antimicrobial solution and the detectable marking agent into the food cavity;

(6) vacuum sealing the food product in the package such that the package cavity and the package shrinks around the food product and the antimicrobial solution and marking agent are uniformity dispersed over the food surface; and

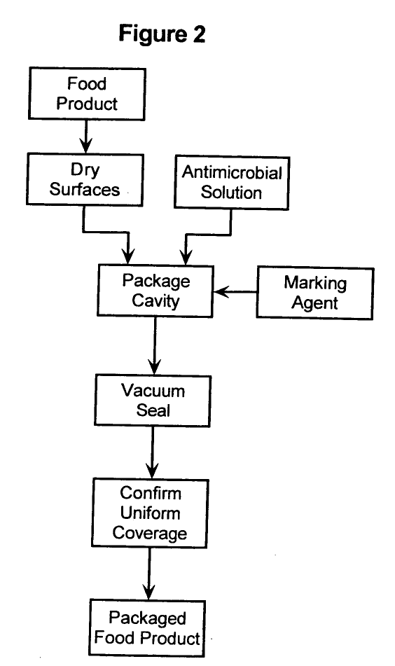

(7) detecting the marking agent to assess proper introduction and dispersion of the antimicrobial agent throughout the package cavity, thereby controlling contamination in the vacuum-sealed product. Preferably the marking agent is included in the antimicrobial solution along with the antimicrobial agent. Preferably the marking agent allows the manufacture to easily confirm substantially complete coverage of the food surfaces by the marking agent and, by implication, the antimicrobial agent. This method is especially adapted for packaging processed meats (e.g., wieners and sliced meat products such as bologna, ham, turkey, and the like). FIG. 2 generally illustrates the methods of this invention using the optional drying step and the optional marking agents.

In preferred embodiments, the marking agent is selected from a wetting agent, a food-grade color, a food-grade dye, a luminescent compound, a fluorescent compound, a high volatility odor-producing compound, as well as activators and suppressors of any of the aforementioned marking agents. In certain preferred embodiments, the marking agent is a food-grade dye that is water soluble, compatible with the color of the food, and diffuses into the food but only affects the color of the food in a visually noticeable way before it diffuses into the food. In other preferred embodiments, the marking agent initially is visually opaque but then clears over time. Thus, by the time the product is purchased by the consumer, the marking agent is no longer evident. For example, a supersaturated aqueous solution or a non-aqueous soluble marker can be used as the marking agent. In such a system, the marking agent can initially form an opaque solution due to the formation of small crystals; over time, the solution will clear.

Methods for detecting the above-listed marking agents are well known. For example where the marking agent is a food-grade dye, coverage of the antimicrobial solution may be assessed by visual inspection of the food surface. As another non-limiting example, where the marking agent is a wetting agent, visual assessment of a change in surface sheen from a dry/matte finish to a wet/shiny finish may be used. As yet another non-limiting example, where the marking agent is a luminescent compound, light emitted by the luminescent compound may be detected with a luminometer. In certain preferred embodiments, the detecting comprises analyzing the processed meat surface for substantially complete coverage, preferably complete coverage, by the marking agent. Such detection may be manual or automatic using appropriate inspection equipment.

In certain preferred embodiments, the detectable antimicrobial compositions of the current invention are combined with the methods described above for controlling contamination of a vacuum-sealed food product. For these embodiments, the antimicrobial solution is the detectable antimicrobial composition, and the method further comprises detecting the detectable antimicrobial solution after packaging.

Also provided are two-step methods using the detectable antimicrobial solutions, which include a marking agent, and a separate marking partner associated with the food or the food surface thereof. In the two-step methods, the marking partner gives the food a characteristic that is unusual for the food. In these embodiments, the marking agent then changes the characteristic in a detectable manner. For example, the marking partner may be a food dye that provides a food an unusual color that is reversed when the food is exposed to a marking agent. By using this method, a process may be monitored to assure that the surface of a food is substantially completely covered by an antimicrobial agent. The marking partner may be any class of food-grade compounds, as described above, that are appropriate for the marking agent.

The following examples describe and illustrate the processes and products of the invention. These examples are intended to be merely illustrative of the present invention, and not limiting thereof in either scope or spirit. Unless indicated otherwise, all percentages and ratios are by weight. Those skilled in the art will readily understand that variations of the materials, conditions, and processes described in these examples can be used. All references cited herein are incorporated by reference.

### EXAMPLE 1

This example provides the general procedure for vacuum sealing wieners for controlling contamination of a vacuum-sealed product. Surface dried wieners (a total of ten weight 1 lb) were packaged with 3.0 grams/lb of water (control samples) or an antimicrobial solution applied at the bottom of the package using the following method. The wieners were placed on top of a bottom section of a two-part continuously extruded plastic sheet for vacuum-sealing. After the wieners were placed on the bottom section, the water or antimicrobial agent (as indicated in the following examples) were applied. The top section was then placed on top of the wieners and a vacuum sealer was used to seal the bottom and top sections together. The vacuum seal was performed using a commercial vacuum sealer at a vacuum pressure of about 26 inches Hg. When the packages were later opened, wet and shiny surfaces were observed indicating complete coverage over the exterior surfaces.

### EXAMPLE 2

This example uses a surface rewetting test to analyze the ability of the liquid application method described in Example 1 to effectively coat or cover the surface of packaged wieners. Surface dried wieners were packaged with water as described in Example 1. Small squares (about 1 mm×1 mm) of “Post-it” paper were applied to wieners at various locations along the top, middle, and bottom of the package. Different physical sublocations within each package were tested including the front and back of links, between links, and against the top or bottom section of the film. Most of the test squares became wetted during the sealing process; all test squares became wetted within 15 minutes after the sealing process was complete.

Adding more liquid resulted in faster and, in some cases, immediate wetting.

Thus, the method described in Example 1 resulted in complete liquid distribution on the surface of the wieners after packaging.

### EXAMPLE 3

This example utilizes a chemical distribution test to analyze the ability of the method described in Example 1 to effectively coat the surface of packaged wieners with an antimicrobial solution. Ten surface dried wieners were repackaged with 3.0 grams of an aqueous antimicrobial solution that included bacteriocins (i.e., nisin and/or pediocin) as the active antimicrobial agent applied at the bottom of the package as described in Example 1. Chemical distribution of the active antimicrobial agent was confirmed using Listeria lawn clearance analysis (wiener skin samples were placed on a Listeria lawn; a clearance zone growing around the sample indicated antimicrobial agent coverage). For this analysis, wieners were stored for 24 hours at about 34° F. after completion of the vacuum-sealing process. Then the wieners were skinned and chemical distribution of the antimicrobial agent using the Listeria lawn clearance technique was measured for 15 samples/package wherein the samples were taken from various locations from the wieners (i.e., first end, middle, second end). Using this method, uniform levels of the active ingredient were measured in all samples.

### EXAMPLE 4

This example utilizes a microbial challenge to analyze the ability of the method described in Example 1 using several antimicrobial agents, to effectively protect the surface of packaged wieners from microbial challenge. Ten surface dried or wet wieners were repackaged with 6.0 grams/lb wiener of an antimicrobial solution that included lactic acid, potassium lactate, and hop extract in a propylene glycol carrier. The antimicrobial agent was applied at one end or at both ends of a package prior to sealing. Microbial challenge was performed by inoculating the packaged wieners with up to 10,000 CFU of a five-strain Listeria cocktail at four different spots within the package; each sampling spot was remote from the location of the actual application of the antimicrobial solution. Microbial inactivation was determined using standard USDA Listeria methods.

Results of these experiments indicated that the vacuum-sealing method for applying the antimicrobial agent was effective for protecting the sealed meat product from microbial contamination (i.e., essentially complete inactivation at locations throughout the packaging). No colony forming units of the challenge microbe were found using the standard USDA Listeria test methods.

### EXAMPLE 5

The total amount of liquid carrier that may be used in the method described in Example 1 for surface coating a food with an antimicrobial agent according to the current invention while maintaining effective heat sealing was analyzed. Based on this evaluation, up to 10.0 grams of total surface water (including surface water on the wieners and added antimicrobial solution) could be incorporated into a package of ten test wieners (i.e., double packages each containing a single layer of five wieners) without adversely effecting the heat seal effectiveness; test wieners had approximately 128 in² surface area per lb of product. Wieners packaged in multilayers within a single package would be expected to accommodate higher volumes of the antimicrobial solution. Generally, however, it is expected that different package or wiener configurations (multilayer packages, jumbo sized or longer length wieners, and the like) will utilize similar liquid film thicknesses to provide bacterial protection and effective heat sealing.

### EXAMPLE 6

A propylene glycol-based antimicrobial solution containing about 20,000 ppm hop extract was added at a level of about 1.1 ml/package to a vacuum sealable package containing five test wieners which had not been surface dried. Since the solubility of the hop extract in the propylene glycol solution was in excess of about 30,000 ppm, the hop extract was completely solubilized in the initial solution. When added to the packaged wieners and vacuum sealed, however, the propylene glycol solution was diluted with about 1.5 g surface water (about 0.3 g surface water/wiener) and the solubility of hop extract drops rapidly to about 10,000 ppm. The sudden solubility drop results in very fine crystal formation which provide a distinct “milky” appearance to the packaged material. This “milky” appearance thereby provides a marker to confirm that the antimicrobial solution is present and that coverage of the exterior surfaces of the wieners is complete. The “milky” appearance gradually disappears within about 1 to 3 weeks of refrigerated storage; thus, by the time the package reaches the consumer market, the “milky” appearance is no longer apparent.

### EXAMPLE 7

Frozen or refrigerated wieners were inoculated with about 10,000 Listeria organisms per five wiener package. The wieners were then exposed to pressurized steam for a short time period (less than about 1 second) to heat the wiener surface. The ends of the heated wiener surfaces were then sprayed with the same propylene glycol-based antimicrobial solution of Example 6 and then vacuum sealed. After 24 hour storage, the complete eradication of Listeria was observed. Control samples prepared without the antimicrobial solution but subject to the same heating and storage regime were positive for Listeria.

Throughout this application, various patents, publications, and/or books, have been cited. The entireties of each of these patents, publications, books, and/or books are hereby incorporated by reference into this application.

1. A method for controlling contamination in a vacuum-sealed food product, said method comprising:
(1) providing a food product with a food surface;
(2) providing a flexible vacuum-sealable package having a package cavity for holding the food product;
(3) drying the food surface of the food product:
(4) introducing an effective amount of an antimicrobial solution containing an antimicrobial agent into only a portion of the package cavity;
(5) placing the food product into the package cavity before, during, or after introducing the antimicrobial solution into the food cavity; and
(6) vacuum sealing the food product in the package such that the package cavity and the package shrinks around the food product and the antimicrobial solution is uniformity dispersed over the food surface, thereby controlling contamination in the vacuum-sealed product.

2. The method of claim 1, wherein the food product is a processed meat.

3. The method of claim 2, wherein the food product is a plurality of wieners, wherein each wiener in the plurality of wieners has a cylindrical body with a first end and second end and wherein the plurality of wieners in the vacuum sealed package are alined along the cylindrical bodies with the first end of each wiener adjacent to the first ends of the other wieners.

4. The method of claim 3, wherein the plurality of wieners consists of 5 to 10 wieners and wherein the effective amount of the antimicrobial solution is about 0.5 to about 10 cm³ and wherein the effective amount of the antimicrobial solution and surface water that may be present on the food surface does not significantly effect vacuum sealing in step (5).

5. (Canceled)

6. The method of claim 4, wherein the antimicrobial solution is introduced into the package cavity by applying the antimicrobial solution in at least a first portion and a second portion wherein the first portion is applied to the first ends of the wieners and the second portion is applied to the second ends of the wieners.

7. The method of claim 1, wherein the antimicrobial agent is selected from the group consisting of food-grade acids, bacteriocins, spice extracts, plant extracts, inorganic salts, methyl paraben, ozonated water, and mixtures thereof.

8. The method of claim 1, wherein the antimicrobial agent is selected from the group consisting of acetic acid, lactic acid, malic acid, phosphoric acid, sorbic acid, benzoic acid, and mixtures thereof.

9. (Canceled)

10. The method of claim 1, wherein a marking agent is also introduced into the package cavity prior to vacuum sealing and wherein the marking agent can be used to confirm that the antimicrobial solution is present and uniformity dispersed over the food surface after vacuum sealing.

11. A method for controlling contamination in a vacuum-sealed food product, said method comprising:
(1) providing a food product with a food surface;
(2) providing a flexible vacuum-sealable package having a package cavity for holding the food product;
(3) drying the food surface of the food product;
(4) introducing an effective amount of an antimicrobial solution containing an antimicrobial agent into only a portion of the package cavity;
(5) introducing a detectable marking agent into the package cavity;
(6) placing the food product into the package cavity before, during, or after introducing the antimicrobial solution and the detectable marking agent into the food cavity;
(7) vacuum sealing the food product in the package such that the package cavity and the package shrinks around the food product and the antimicrobial solution and marking agent are uniformity dispersed over the food surface; and
(8) detecting the marking agent to assess proper introduction and dispersion of the antimicrobial agent throughout the package cavity, thereby controlling contamination in the vacuum-sealed product.

12. The method of claim 11, wherein the food product is a processed meat.

13. The method of claim 12, wherein the food product is a plurality of wieners wherein each wiener in the plurality of wieners has a cylindrical body with a first end and second end and wherein the plurality of wieners in the vacuum sealed package are alined along the cylindrical bodies with the first end of each wiener adjacent to the first ends of the other wieners.

14. The method of claim 11, wherein the marking agent is selected from the group consisting of food-grade wetting agents, food-grade colors, food-grade dyes, food-grade luminescent compounds, food-grade fluorescent compounds, food-grade odor-producing compounds, and food-grade activators and suppressors thereof.

15. The method of claim 13, wherein the antimicrobial solution is introduced into the package cavity by applying the antimicrobial solution in at least a first portion and a second portion wherein the first portion is applied to the first ends of the wieners and the second portion is applied to the second ends of the wieners.

16. The method of claim 12, wherein the marking agent is selected from the group consisting of food-grade wetting agents, food-grade colors, food-grade dyes, food-grade luminescent compounds, food-grade fluorescent compounds, food-grade odor-producing compounds, and food-grade activators and suppressors thereof.

17. The method of claim 15, wherein the marking agent is selected from the group consisting of food-grade wetting agents, food-grade colors, food-grade dyes, food-grade luminescent compounds, food-grade fluorescent compounds, food-grade odor-producing compounds, and food-grade activators and suppressors thereof.

18. The method of claim 13, wherein the plurality of wieners consists of 5 to 10 wieners and wherein the effective amount of the antimicrobial solution is about 0.5 to about 10 cm³ and wherein the effective amount of the antimicrobial solution and surface water that may be present on the food surface does not significantly effect vacuum sealing in step (6).

19. (Canceled)

20. The method of claim 11, wherein the antimicrobial agent is selected from the group consisting of food-grade acids, bacteriocins, spice extracts, plant extracts, inorganic salts, methyl paraben, ozonated water, and mixtures thereof.

21. The method of claim 11, wherein the antimicrobial agent is selected from the group consisting of acetic acid, lactic acid, malic acid, phosphoric acid, sorbic acid, benzoic acid, and mixtures thereof.

22. The method of claim 18, wherein the antimicrobial agent is selected from the group consisting of food-grade acids, bacteriocins, spice extracts, plant extracts, inorganic salts, methyl paraben, ozonated water, and mixtures thereof.

23. The method of claim 18, wherein the antimicrobial agent is selected from the group consisting of acetic acid, lactic acid, malic acid, phosphoric acid, sorbic acid, benzoic acid, and mixtures thereof.

24. The method of claim 1, wherein the antimicrobial agent is a plant extract.

25. The method of claim 24, wherein the plant is a hop extract.

26. The method of claim 11, wherein the antimicrobial agent is a plant extract.

27. The method of claim 26, wherein the plant is a hop extract.
